(19) United States
(12) Patent Application Publication
(10) Pub. No.: US 2026/0228463 A1
(43) Pub. Date: Aug. 6, 2026

(54) BEST CONNECT TRANSLATOR SYSTEM, METHOD, AND PLATFORM

(71) Applicant: Mike Brooks, Brooklyn, NY (US)

(72) Inventor: Mike Brooks, Brooklyn, NY (US)

(21) Appl. No.: 19/044,188

(22) Filed: Feb. 3, 2025

(51) Int. Cl. G06F 40/58; H04L 51/063

(52) U.S. Cl. CPC G06F 40/58; H04L 51/063

(57) ABSTRACT

A method for facilitating multilingual communication in a chat environment may include receiving a first message in a first language from a first user. The first language of the first message may be detected. A plurality of target languages associated with other users in the chat may be identified. The first message may be translated from the first language into each of the plurality of target languages to generate a plurality of translated messages. The first message and the plurality of translated messages may be transmitted to the plurality of other users. A respective computing device of each of the plurality of other users may display the first message and a corresponding translated message from the plurality of translated messages. The method may further include receiving and storing language preference selections from users, analyzing message content or retrieving pre-specified preferences to detect languages, and displaying messages in visually distinguishable formats.

### FIELD OF THE INVENTION

This disclosure relates to the field of communication technology. More specifically, it pertains to multilingual messaging systems for real-time translation in chat environments. More specifically, embodiments of this present disclosure relate to one or more of the following CPC classifications: G06F40/42 Data-driven translation; G06F40/00—Handling natural language data; G06F40/40—Processing or translation of natural language; G06F40/44—Statistical methods, e.g. probability models; G06F40/45 Example-based machine translation; G06F40/47-Machine-assisted translation, e.g. using translation memory; G06F40/49-Data-driven translation using very large corpora, e.g. the web; G06F40/58 Use of machine translation, e.g. for multi-lingual retrieval, for server-side translation for client devices or for real-time translation; G06F3/0484 Interaction techniques based on graphical user interfaces [GUI] for the control of specific functions or operations, e.g. selecting or manipulating an object, an image or a displayed text element, setting a parameter value or selecting a range; G06F3/1423 Digital output to display device ; Cooperation and interconnection of the display device with other functional units controlling a plurality of local displays, e.g. CRT and flat panel display; G06F40/166 Editing, e.g. inserting or deleting; H04L65/4015 Support for services or applications wherein the services involve a main real-time session and one or more additional parallel real-time or time sensitive sessions, e.g. white board sharing or spawning of a subconference where at least one of the additional parallel sessions is real time or time sensitive, e.g. white board sharing, collaboration or spawning of a subconference; H04L65/403 Arrangements for multi-party communication, e.g. for conferences.

### BACKGROUND

The present disclosure relates generally to multilingual communication systems and methods, and more particularly to real-time text-based translation in multi-user chat environments. With the increasing globalization of business and social interactions, there is a growing need for effective communication across language barriers. Traditional methods of translation often involve manual processes or separate translation tools, which can be time-consuming and disrupt the flow of conversation. Existing translation systems may lack the ability to seamlessly integrate multiple languages in a single chat environment or may require users to perform additional steps to translate messages.

Therefore, there is a need for improved systems and methods for facilitating real-time multilingual communication in text-based chat environments.

### BRIEF OVERVIEW

The present disclosure provides systems, methods, and apparatus for facilitating real-time multilingual communication in text-based chat environments. In various embodiments, a Best Connect Translator (BCT) system may enable users speaking different languages to communicate seamlessly in a single chat environment. The system may automatically detect and translate messages between multiple languages without requiring manual intervention from users.

It should be appreciated that this Brief Overview is provided to introduce a selection of concepts in a simplified form that are further described below in the Detailed Description. This Brief Overview is not intended to identify key features or essential features of the claimed subject matter, nor is it intended to be used as an aid in determining the scope of the claimed subject matter. The claimed subject matter is not limited to implementations that solve any or all disadvantages noted in the Background.

These together with additional objects, features and advantages of the system for managing synthetic genetic codes will be readily apparent to those of ordinary skill in the art upon reading the following detailed description of the presently preferred, but nonetheless illustrative, embodiments when taken in conjunction with the accompanying drawings. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are and explanatory only and are not restrictive of the disclosure, as claimed.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

The accompanying drawings, which are incorporated in and constitute a part of this specification, illustrate embodiments of the disclosure and, together with a general description of the disclosure given above, and the detailed description given below, serve to explain the principles of the disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the Applicants. The Applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. The Detailed Description is described with reference to the accompanying figures. The use of the same reference numbers in different figures indicates similar or identical items.

FIG. 1 is a diagram illustrating an example operating environment of a Best Connect Translator (BCT) system, in accordance with various embodiments.

FIG. 2 is a diagram illustrating an example user interface for language selection in a BCT system, in accordance with various embodiments.

FIG. 3 is a diagram illustrating an example chat interface in a BCT system, in accordance with various embodiments.

FIG. 4 is a flow diagram illustrating an example method for facilitating multilingual communication in a BCT system, in accordance with various embodiments.

FIG. 5 is a flow diagram illustrating an example method for processing messages in a BCT system, in accordance with various embodiments.

FIG. 6 is a block diagram illustrating an example computing device that may be used to implement various aspects of a BCT system, in accordance with various embodiments.

### DETAILED DESCRIPTION

The present disclosure describes various embodiments of systems, methods, and apparatus for facilitating real-time multilingual communication in text-based chat environments. While specific examples and implementations are discussed, it should be understood that this is done for illustration purposes only. Other components and configurations may be used without departing from the spirit and scope of the disclosure.

The present disclosure includes many aspects and features. Moreover, while many aspects and features relate to, and are described in, the context of systems and methods of fraud identification, embodiments of the present disclosure are not limited to use only in this context. The present disclosure can be understood more readily by reference to the following detailed description of the disclosure and the examples included therein.

Before the present articles, systems, apparatuses, and/or methods are disclosed and described, it is to be understood that they are not limited to specific methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,”“second,” “first part,” “second part,” and the like, where used herein, do not denote any order, quantity, or importance, and are used to distinguish one element from another, unless specifically stated otherwise. As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

It is understood that the apparatuses and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

The following description of various embodiments is merely exemplary in nature and is in no way intended to limit the disclosure, its application, or uses.

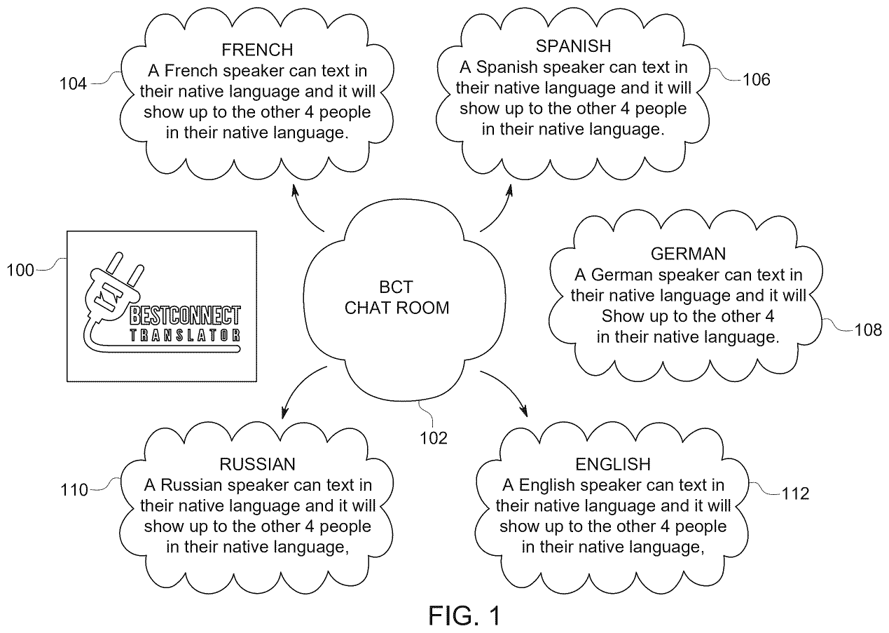

Referring to FIG. 1, FIG. 1 illustrates an example operating environment 100 of a Best Connect Translator (BCT) system, in accordance with various embodiments. The BCT system may include a central BCT chatroom 102 that facilitates communication between users speaking different languages. In the illustrated example, the BCT chatroom 102 may support communication between users speaking French 104, Spanish 106, German 108, Russian 110, and English 112. However, it should be understood that the BCT system may support any number of languages and users.

In operation, each user may text in their native language, and the BCT system may automatically translate the messages into the preferred languages of the other users in the chatroom. For example, when a French speaker texts in French, the message may be automatically translated and displayed to the other users in their respective native languages (Spanish, German, Russian, and English in this example).

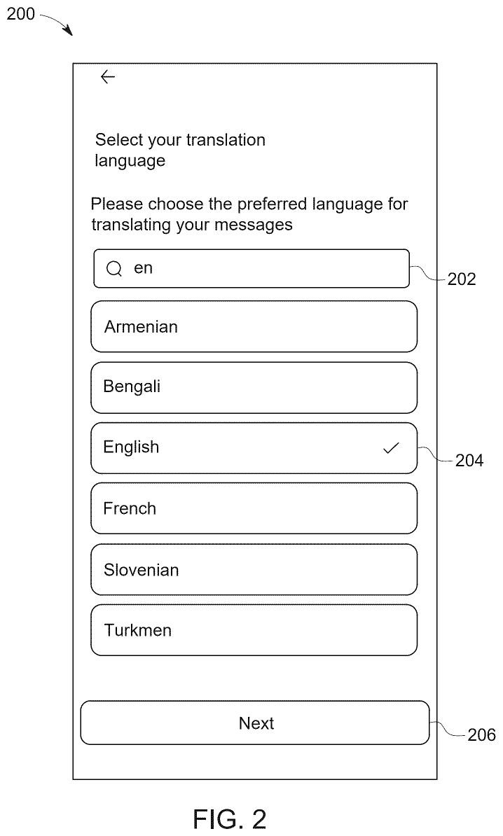

Referring to FIG. 2, FIG. 2 illustrates an example user interface 200 for language selection in a BCT system, in accordance with various embodiments. The user interface 200 may allow users to select their preferred language for translation. In the illustrated example, the interface includes options for selecting various languages such as Armenian, Bengali, English, French, Slovenian, and Turkmen. However, it should be understood that the BCT system may support any number of languages, and the user interface may be configured to display and allow selection of additional languages. The user interface 200 may include a search field 202 that allows users to quickly find their preferred language. Once a language is selected, it may be highlighted or marked with a check mark 204, as shown for the English option in the example. A “Next” button 206 may be provided to confirm the language selection and proceed to the chat interface.

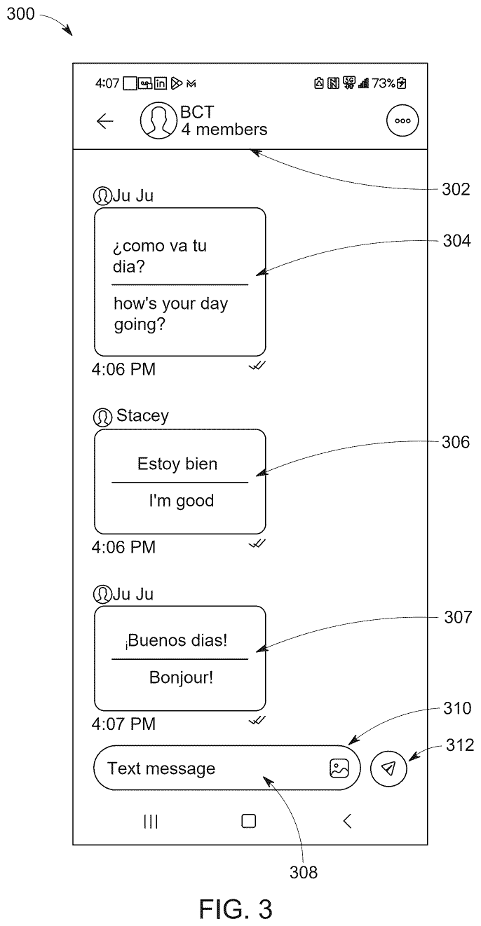

Referring to FIG. 3, FIG. 3 illustrates an example chat interface 300 in a BCT system, in accordance with various embodiments. The chat interface 300 may display messages from multiple users in a single chatroom. In the illustrated example, the interface shows a chatroom with 4 members, as indicated by the text 302 at the top of the screen. Each message in the chat interface may be displayed with the original text and its translation. For example, a message from user “JuJu” at 4:06 PM shows the original Spanish text “¿como va tu dia?” followed by its English translation “how's your day going?” 304. Similarly, a message from user “Stacey” at 4:06 PM shows “Estoy bien” with its translation “I'm good” 306. Furthermore, a response message from user “JuJu” at 4:07 PM shows “Buenos dias!” with its translation “Bonjour!” 307. The chat interface may also include a text input box 308 where users can type their messages, along with additional features such as a camera button 310 for sending images and a send button 312 for transmitting messages.

### Methods of Use

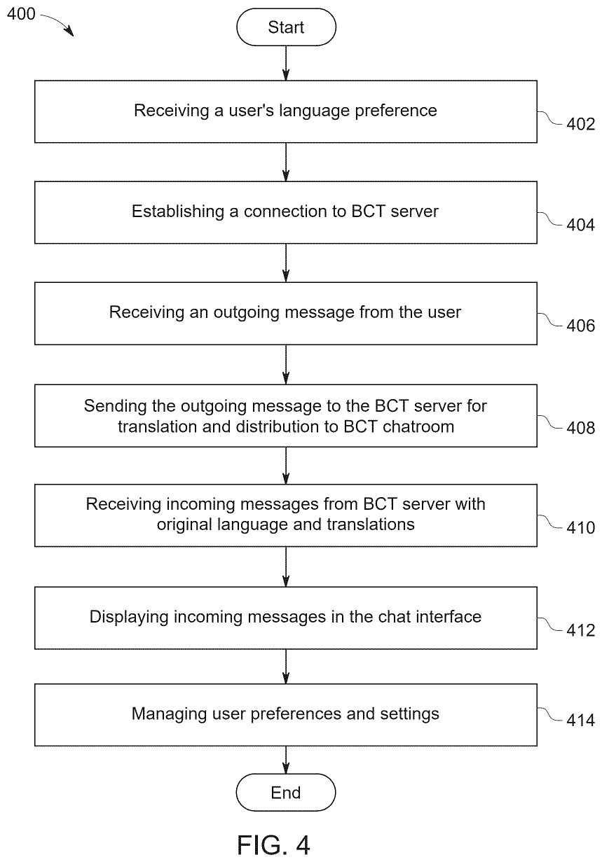

Referring to FIG. 4, FIG. 4 is a flow diagram illustrating an example method 400 for facilitating multilingual communication in a BCT system, in accordance with various embodiments. The method 400 may begin at step 402, where the system may receive a user's language preference. This may occur, for example, when a user first sets up their account or changes their language settings. At step 404, the system may establish a connection to the BCT server. This connection may be used for sending and receiving messages, as well as for performing translations. At step 406, the system may receive an outgoing message from the user. This message may be in the user's preferred language as selected in step 402. At step 408, the system may send the outgoing message to the BCT server for translation and distribution to other users in the chatroom. At step 410, the system may receive incoming messages from the BCT server. These incoming messages may include both the original text and translations into the user's preferred language. At step 412, the system may display the incoming messages in the chat interface, showing both the original text and the translation as illustrated in FIG. 3. At step 414, the system may manage user preferences and settings. This may include allowing the user to change their preferred language, adjust display settings, or modify other aspects of their BCT experience.

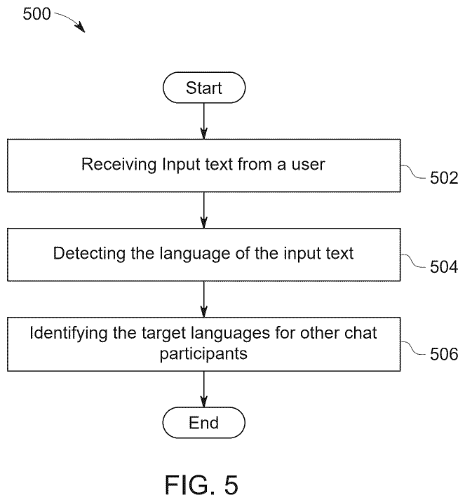

Referring to FIG. 5, FIG. 5 is a flow diagram illustrating an example method 500 for processing messages in a BCT system, in accordance with various embodiments. The method 500 may begin at step 502, where the system may receive an input text from a user. At step 504, the system may detect the language of the input text. This may be done using various language detection algorithms or by referencing the user's specified preferred language. At step 506, the system may identify the target languages for other chat participants. This may involve referencing the language preferences of all other users currently in the chatroom.

### Applications of BCT System, Method and Platform

The method of use for the Best Connect Translator (BCT) may be expanded to incorporate alternative and expanded methods of use in larger operating environments. For example, the BCT system may be integrated into various communication platforms beyond standalone chat applications. The BCT functionality may be incorporated as a plugin or extension for existing messaging applications, email clients, or social media platforms. This integration may allow users to seamlessly translate messages across different communication channels without switching between separate apps.

In larger corporate or educational environments, the BCT system may be deployed as an enterprise-wide solution. This expanded use case may enable multilingual communication across departments, international offices, or global classrooms. The system may be customized to include industry-specific terminology and jargon to enhance translation accuracy in specialized fields.

The BCT method may also be adapted for use in real-time voice and video communication platforms. In this expanded application, the system may provide simultaneous interpretation capabilities for multilingual video conferences or webinars. Speech recognition technology may be employed to convert spoken words into text, which may then be translated and displayed as subtitles or synthesized into spoken audio in the target language.

For larger events such as international conferences or global town hall meetings, the BCT system may be scaled to support hundreds or thousands of simultaneous users across multiple languages. This expanded use case may require advanced load balancing and distributed processing capabilities to handle the increased volume of translations in real-time.

The method may also be extended to support offline functionality, allowing users to communicate in multilingual environments without constant internet connectivity. This expanded use case may involve downloading language packs and employing on-device translation models for basic communication when network access is limited.

In public spaces such as airports, train stations, or tourist attractions, the BCT system may be integrated into information kiosks or mobile apps. This expanded method of use may allow visitors to communicate with staff or access information in their preferred language, enhancing the user experience in multilingual environments.

The BCT method may also be applied to document translation scenarios, allowing users to collaborate on multilingual documents in real-time. This expanded use case may involve integrating the translation capabilities into word processing or document sharing platforms, enabling seamless multilingual collaboration on reports, presentations, or research papers.

For accessibility purposes, the BCT system may be expanded to include support for sign language translation. This method may involve using computer vision techniques to recognize sign language gestures and convert them into text or synthesized speech in various languages, and vice versa.

In the context of augmented reality (AR) applications, the BCT method may be used to provide real-time translation of text in the physical world. Users may point their device's camera at signs, menus, or other text, and the translated version may be overlaid on the screen in their preferred language. These expanded methods of use demonstrate the versatility and scalability of the BCT system in larger operating environments, showcasing its potential applications across various industries and communication scenarios. The Best Connect Translator (BCT) system may be implemented in various operating environments, ranging from small-scale personal devices to large-scale enterprise solutions. In smaller operating environments, the BCT system may be deployed on individual mobile devices or personal computers. These devices may include smartphones, tablets, laptops, or desktop computers running the BCT application.

For larger operating environments, the BCT system may be implemented as a cloud-based service capable of handling multiple concurrent users across different geographic locations. This scalable architecture may allow for enterprise-wide deployment, supporting large corporations with offices in different countries or educational institutions with international student bodies. The system may also be integrated into existing communication platforms, such as popular messaging apps or social media networks. This integration may enable users to access BCT functionality within their preferred communication channels, expanding the reach and accessibility of the multilingual translation features.

In public spaces, the BCT system may be incorporated into information kiosks or interactive displays. These installations may provide on-the-spot translation services for tourists, visitors, or local residents who need assistance communicating across language barriers. For large-scale events such as international conferences or global town halls, the BCT system may be deployed as a dedicated translation solution. This implementation may support real-time multilingual communication among attendees, speakers, and organizers, facilitating seamless interaction regardless of language differences.

The BCT system may also be adapted for use in customer service environments, such as call centers or online support platforms. This application may enable customer service representatives to communicate effectively with clients from diverse linguistic backgrounds, improving customer satisfaction and expanding global reach. In educational settings, the BCT system may be integrated into virtual learning environments or distance education platforms. This integration may allow students and educators from different countries to collaborate on projects, participate in discussions, and share knowledge without language barriers impeding their interactions,

For global businesses, the BCT system may be implemented in document collaboration tools and project management platforms. This implementation may facilitate real-time translation of shared documents, comments, and communications, enabling seamless collaboration among multinational teams.

The BCT system may also find applications in healthcare environments, such as hospitals or telemedicine platforms. In these settings, the system may aid in patient-doctor communications, ensuring accurate translation of medical information and improving healthcare outcomes for patients with limited language proficiency. The BCT system may include alternative components and elements for optimal and minimal operation. For optimal performance, the system may incorporate high-performance processors capable of handling complex natural language processing tasks in real-time. These processors may be multi-core CPUs or specialized AI accelerator chips designed for language translation workloads.

The system may utilize advanced machine learning models, such as transformer-based neural networks, to achieve high-quality translations across multiple language pairs. These models may be regularly updated and fine-tuned to improve translation accuracy and handle nuanced language expressions.

For optimal network performance, the BCT system may employ low-latency communication protocols and edge computing techniques to minimize translation delays. This may include deploying translation models closer to end-users through a distributed network of edge servers. The user interface may feature customizable themes and layouts to enhance user experience and accessibility. Advanced text-to-speech and speech-to-text capabilities may be integrated to support voice-based interactions in addition to text-based communication.

For minimal operation, the BCT system may utilize lightweight translation models that can run efficiently on resource-constrained devices. These models may sacrifice some translation quality for improved speed and reduced computational requirements. A simplified user interface may be implemented, focusing on essential features like language selection and message display. The system may limit the number of concurrent languages supported in a single chat session to reduce complexity and resource usage.

Offline functionality may be provided through pre-downloaded language packs, allowing basic translation capabilities without an active internet connection. This may be particularly useful in areas with limited connectivity. The BCT system may also incorporate fallback mechanisms to ensure continued operation in suboptimal conditions. For instance, if real-time translation is not possible due to network issues, the system may queue messages for translation when connectivity is restored.

By offering both optimal and minimal configurations, the BCT system may cater to a wide range of use cases and device capabilities, ensuring broad accessibility and adaptability to various operating environments. The BCT system may offer several technical advantages over existing translation solutions:
1. Real-time multilingual group communication: The system may enable seamless communication between users speaking different languages in a single chatroom environment. This may eliminate language barriers and facilitate collaboration across linguistic boundaries.
2. Automatic language detection and translation: The system may automatically detect the input language and translate messages into each user's preferred language without manual intervention. This may streamline the communication process and reduce cognitive load on users.
3. Scalable architecture: The BCT system may be designed to support an expanding number of languages and users. This scalability may allow the system to adapt to diverse communication needs across various industries and use cases.
4. Customizable user experience: Users may have the ability to select and change their preferred language at any time. This flexibility may accommodate dynamic communication scenarios and user preferences.
5. Efficient message processing: The system may employ advanced natural language processing and machine learning techniques to provide accurate translations while maintaining low latency. This may enable near real-time communication across language barriers.
6. Integrated display of original and translated text: The user interface may present both the original message and its translation in a visually distinct manner. This approach may preserve context and nuance while providing clear language support.
7. Cross-platform compatibility: The BCT system may be implemented across various devices and operating systems, potentially including mobile applications, desktop software, and web-based interfaces. This versatility may increase accessibility and adoption.
8. Enhanced privacy and security: By processing translations within a dedicated system, the BCT may offer improved data protection compared to solutions that rely on third-party translation services.
9. Support for specialized terminology: The system may be adaptable to include domain-specific vocabularies, making it suitable for professional, technical, or industry-specific communication scenarios.
10. Offline capabilities: With downloadable language packs, the system may offer translation functionality even in situations with limited or no internet connectivity.

These technical advantages may position the BCT system as a comprehensive solution for breaking down language barriers in various communication contexts, from casual conversations to professional collaborations and large-scale events.

### Platform and System Hardware

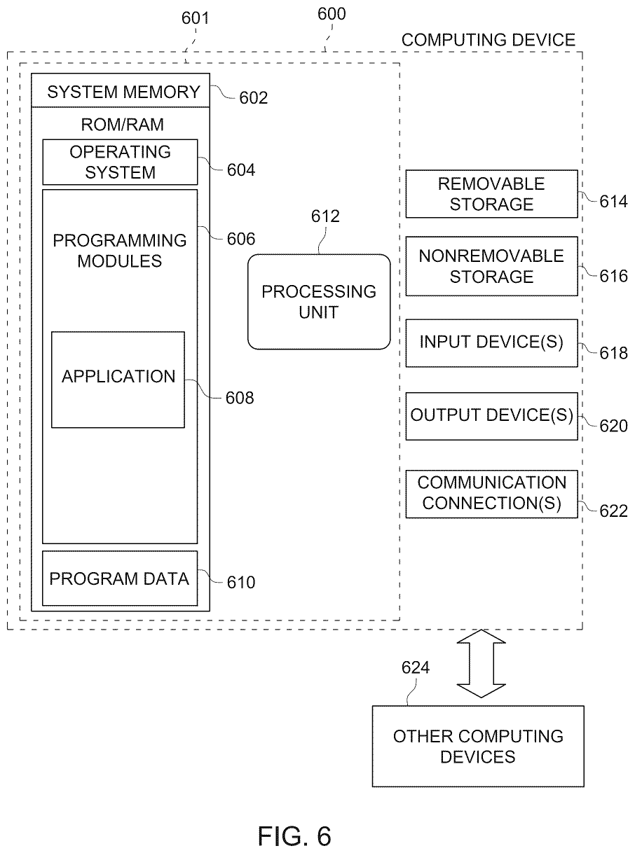

Referring to FIG. 6, FIG. 6 is a block diagram illustrating an example computing device 600 that may be used to implement various aspects of a BCT system, in accordance with various embodiments. The computing device 600 may be a server, a client device, or any other suitable computing device capable of implementing the BCT system. The computing device 600 may include one or more processors 612 capable of processing instructions for execution within the computing device 600. The processor(s) 612 may include single-threaded or multi-threaded processors to enable parallel processing of instructions. The computing device 600 may also include memory 602 that stores information within the computing device 600. The memory 602 may include volatile and/or non-volatile memory and may store instructions to be executed by the processor(s) 612. The memory 602 may also store data structures, program modules, or other data. The computing device 600 may include a storage system 614, 616 that provides additional storage capacity. The storage system may include removable storage 614 and/or non-removable storage 616. The storage system may include various computer-readable storage media such as magnetic disks, optical disks, solid state drives, or any other suitable storage media. The computing device 600 may include input device(s) 618 such as a keyboard, mouse, pen, voice input device, touch input device, or other suitable input devices. Output device(s) 620 such as a display, speakers, printer, or other suitable output devices may also be included. The computing device 600 may also include one or more communication connections 622 that allow the device to communicate with other computing devices 624. The communication connections 622 may include various types of standard communication elements, such as one or more communications interfaces, network interfaces, network interface cards (NICs), radios, wireless transmitters/receivers (transceivers), wired and/or wireless communication media, physical connectors, and so forth.

The components, modules, functions, and techniques discussed herein may be implemented in software, hardware, firmware, or a combination thereof. Various components, modules, or units have been described to emphasize functional aspects and do not necessarily require realization by different hardware units.

The techniques described herein may be implemented in software executed by one or more processors, hardware, firmware, or any combination thereof. If implemented in software, the techniques may be realized at least in part by a computer-readable medium (e.g., memory 602) comprising instructions that, when executed, performs one or more of the methods described above. The computer-readable medium may form part of a computer program product, which may include packaging materials.

The computer-readable medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates code in the form of instructions or data structures and that can be accessed, read, and/or executed by a computer.

The code or instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 614 and a non-removable storage 616. Computer storage media may include volatile and nonvolatile, removable and non-removable media implemented in any method or technology for storage of information, such as computer readable instructions, data structures, program modules, or other data. System memory 602, removable storage 614, and non-removable storage 616 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 618 such as a keyboard, a mouse, a pen, a sound input device, a touch input device, etc. Output device(s) 620 such as a display, speakers, a printer, etc. may also be included. The aforementioned devices are examples and others may be used.

Computing device 600 may also contain a communication connections that may allow device 600 to communicate with other computing devices 624, such as over a network in a distributed computing environment, for example, an intranet or the Internet. Communication connection is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 602, including operating system 604. While executing on processing unit 612, programming modules 606 (application 608) may perform processes including, for example, one or more of method 100's stages as described above. The aforementioned process is an example, and processing unit 612 may perform other processes. Other programming modules that may be used in accordance with embodiments of the present disclosure may include electronic mail and contacts applications, word processing applications, spreadsheet applications, database applications, slide presentation applications, drawing or computer-aided application programs, etc.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, multiprocessor systems, microprocessor-based or programmable consumer electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium, More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and quantum computing elements. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

With respect to the above description, it is to be realized that the optimum dimensional relationship for the various components of the invention described above and in the illustrations include variations in size, materials, shape, form, function, and manner of operation, assembly and use, are deemed readily apparent and obvious to one skilled in the art, and all equivalent relationships to those illustrates in the drawings and described in the specification are intended to be encompassed by the invention.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computer processors, not only residing within a single machine, but deployed across a number of machines.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below. Various embodiments of the invention have been described. These and other embodiments are within the scope of the following claims.

What is claimed is:

1. A method for facilitating multilingual communication in a chat environment, the method comprising:
receiving, by a computing device, a first message in a first language from a first user,
detecting, by the computing device, the first language of the first message;
identifying, by the computing device, a plurality of target languages associated with a plurality of other users in the chat environment;
translating, by the computing device, the first message from the first language into each of the plurality of target languages to generate a plurality of translated messages;
transmitting, by the computing device, the first message and the plurality of translated messages to the plurality of other users; and
displaying, by a respective computing device of each of the plurality of other users, the first message and a corresponding translated message from the plurality of translated messages.

2. The method of claim 1, further comprising:
receiving, by the computing device, a language preference selection from each of the plurality of users; and
storing, by the computing device, the language preference selection for each of the plurality of users.

3. The method of claim 2, wherein identifying the plurality of target languages comprises retrieving the stored language preference selection for each of the plurality of other users.

4. The method of claim 1, wherein detecting the first language of the first message comprises:
analyzing, by the computing device, content of the first message using a language detection algorithm; or
retrieving, by the computing device, a pre-specified language preference associated with the first user.

5. The method of claim 1, wherein displaying the first message and the corresponding translated message comprises:
displaying the first message in a first format; and
displaying the corresponding translated message in a second format visually distinguishable from the first format.

6. The method of claim 5, wherein the second format comprises at least one of: a different color, a different font, italics, or positioning below the first message.

7. The method of claim 1, further comprising:
receiving, by the computing device, a request from a user to change a preferred language;
updating, by the computing device, a stored language preference for the user; and
translating subsequent messages for the user based on the updated language preference.

8. A system for facilitating multilingual communication in a chat environment, the system comprising:
a processor; and
a memory coupled to the processor, the memory storing instructions that, when executed by the processor, cause the system to:
receive a first message in a first language from a first user;
detect the first language of the first message;
identify a plurality of target languages associated with a plurality of other users in the chat environment;
translate the first message from the first language into each of the plurality of target languages to generate a plurality of translated messages;
transmit the first message and the plurality of translated messages to the plurality of other users; and
cause display, on a respective computing device of each of the plurality of other users, of the first message and a corresponding translated message from the plurality of translated messages.

9. The system of claim 8, wherein the instructions further cause the system to:
receive a language preference selection from each of the plurality of users; and
store the language preference selection for each of the plurality of users.

10. The system of claim 9, wherein identifying the plurality of target languages comprises retrieving the stored language preference selection for each of the plurality of other users.

11. The system of claim 8, wherein detecting the first language of the first message comprises:
analyzing content of the first message using a language detection algorithm; or
retrieving a pre-specified language preference associated with the first user.

12. The system of claim 8, wherein causing display of the first message and the corresponding translated message comprises:
causing display of the first message in a first format; and
causing display of the corresponding translated message in a second format visually distinguishable from the first format.

13. The system of claim 12, wherein the second format comprises at least one of: a different color, a different font, italics, or positioning below the first message.

14. The system of claim 8, wherein the instructions further cause the system to:
receive a request from a user to change a preferred language;
update a stored language preference for the user; and
translate subsequent messages for the user based on the updated language preference.

15. A non-transitory computer-readable storage medium storing instructions that, when executed by a processor, cause the processor to perform a method for facilitating multilingual communication in a chat environment, the method comprising:
receiving a first message in a first language from a first user;
detecting the first language of the first message;
identifying a plurality of target languages associated with a plurality of other users in the chat environment;
translating the first message from the first language into each of the plurality of target languages to generate a plurality of translated messages;
transmitting the first message and the plurality of translated messages to the plurality of other users; and
causing display, on a respective computing device of each of the plurality of other users, of the first message and a corresponding translated message from the plurality of translated messages.

16. The non-transitory computer-readable storage medium of claim 15, wherein the method further comprises:
receiving a language preference selection from each of the plurality of users; and
storing the language preference selection for each of the plurality of users.

17. The non-transitory computer-readable storage medium of claim 16, wherein identifying the plurality of target languages comprises retrieving the stored language preference selection for each of the plurality of other users.

18. The non-transitory computer-readable storage medium of claim 15, wherein detecting the first language of the first message comprises:
analyzing content of the first message using a language detection algorithm; or
retrieving a pre-specified language preference associated with the first user.

19. The non-transitory computer-readable storage medium of claim 15, wherein causing display of the first message and the corresponding translated message comprises:
causing display of the first message in a first format; and
causing display of the corresponding translated message in a second format visually distinguishable from the first format.

20. The non-transitory computer-readable storage medium of claim 15, wherein the method further comprises:
receiving a request from a user to change a preferred language;
updating a stored language preference for the user; and
translating subsequent messages for the user based on the updated language preference.
